(19) United States
(12) Patent Application Publication
(10) Pub. No.: US 2013/0024726 A1
(43) Pub. Date: Jan. 24, 2013

(54) SYSTEM AND METHOD FOR REMOVABLE NETWORK ATTACHED STORAGE ENABLING SYSTEM RECOVERY FROM BACKUP

(71) Applicants: Carlton A. Andrews, Austin, TX (US); Yuan-Chang Lo, Austin, TX (US)

(72) Inventors: Carlton A. Andrews, Austin, TX (US); Yuan-Chang Lo, Austin, TX (US)

(73) Assignee: DELL PRODUCTS L.P., Round Rock, TX (US)

(21) Appl. No.: 13/187,219

(22) Filed: Jul. 20, 2011

(51) Int. Cl. G06F 11/14; G06F 15/177

(52) U.S. Cl. 714/15; 713/2; 714/E11.113

(57) ABSTRACT

A system and method for enabling recovery from backup is disclosed. The removable system may include a processor, a memory, a network interface, a backup management module configured to backup data associated with an information handling system communicatively coupled together. The system may be further configured to boot and restore data associated with the information handling system to which the memory is locally attached. The method may include copying data from an information handling system via the network to memory. The method may further include booting and restoring copied data to the information handling system from the locally attached memory. The system and method may further include an article of manufacture including a computer-readable medium and computer-executable instructions operable to copy data, determine the identity of, boot and restore copied data to an information handling system.

### TECHNICAL FIELD

The present disclosure relates in general to information handling systems, and more particularly to a system and method for backing up and restoring data on an information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

With recent advances in network technology and improved affordability of networking devices, information handling system users and business are increasingly implementing networks and systems (e.g., local areas networks or LANs) that utilize wireless transmissions (e.g., wireless fidelity or “Wi-Fi”) and wire-line transmissions in more than one location or in a home without the direct support of an Information Technology (IT) organization. For example, users may implement a home or small business network including using one or more information handling systems and a wire-line or wireless network communicatively coupled to the information handling systems. Such a network may allow an information handling system (or a user thereof) to communicate with the one or more network devices such as a network attached storage device (NAS) or external storage resources, via the network.

Another critical aspect of a network with multiple information handling systems is the management of data. Periodic backups of data from each information handling system may be stored on a NAS. These backups often consist of images of the information handling systems which can be used to restore a system to a fully bootable and functional state quickly. Backup images of a system include operating systems, device drivers, installed application, user preference, user data and any other files located on the information handling system.

However, for small businesses and unmanaged network environments, restoring the failed system or disk is often not a simple process when the backup image is stored on a separate storage device such as a NAS. Because the system may not be bootable from the disk drive or from the NAS, an alternate means of booting, such as a CD or network, must be used. Also, one may need to locate the boot media or device in order to boot.

In addition, the recovery operating system (OS) booted from the CD or network may not have the correct drivers to enable network connectivity for the information handling system that needs to be restored. The network interface used on the information handling system may be unknown to the OS on the boot media as the information handling system may be very new or obscure when that media was created. Finding and inserting the needed drivers in order to browse the network can be too difficult for small business with no dedicated information technology (IT) support staff. Also, not all recovery supports user insertion of additional drivers.

In addition, another problem is that in an unmanaged environment, the average user may not know the IP address of the backup device, such as NAS, where the recovery image data resides and where the image for that particular information handling system is stored.

In addition, another problem is that network access speed may be slow enough that time spent recovering the system image has a significant impact on the business. Minimizing the recovery time may be extremely significant if a small business finds itself crippled or shut down by having a primary information handling system offline.

Accordingly, a need has arisen for a method and system to facilitate fast backup and recovery of data for information handling systems in a home or small business environment.

### SUMMARY

In accordance with the teachings of the present disclosure, disadvantages and problems associated with enabling recovery from backups may be substantially reduced or eliminated.

In accordance with embodiments of the present disclosure, a removable system for enabling recovery from backups may include a processor, a network interface, a backup management module, and a memory communicatively coupled together. The backup management module may be further configured to backup data associated with one or more information handling systems. The memory may be configured to include a boot partition comprising a program of instructions, when executed by a processor, are operable to boot and restore data associated with the information handling system to which the memory is locally attached.

In accordance with further embodiments of the present disclosure, a method for enabling recovery from backup may include copying data from an information handling system to a memory communicatively coupled to the information handling system. The method may include locally communicatively coupling the memory to the information handling system after a failure of the information handling system. The method may further include booting and restoring copied data from locally attached memory to the information handling system.

In accordance with further embodiments of the present disclosure, a system and method for enabling recovery from backup may include an article of manufacture. The article of manufacture may include a computer-readable medium and computer-executable instruction carried on the computer-readable medium. The instruction, when executed, may be operable to copy data from an information handling system communicatively coupled to the memory. The instructions may be further operable to determine the identity of an information handling system that the memory is locally attached to. The instructions may be further operable to boot and restore copied data from the memory to the information handling system.

Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system including a network attached hub with one or more removable external storage resources, in accordance with certain embodiments of the present disclosure;

FIG. 2 illustrates a block diagram of an example configuration of the system of FIG. 1 in which recovery of an information handling system is performed from a backup in accordance with certain embodiments of the present disclosure; and

FIG. 3 illustrates a flow chart of a method for a network attached hub coupled to a removable external storage device enabling recovery from backup, in accordance with certain embodiments of the present disclosure.

### DETAILED DESCRIPTION

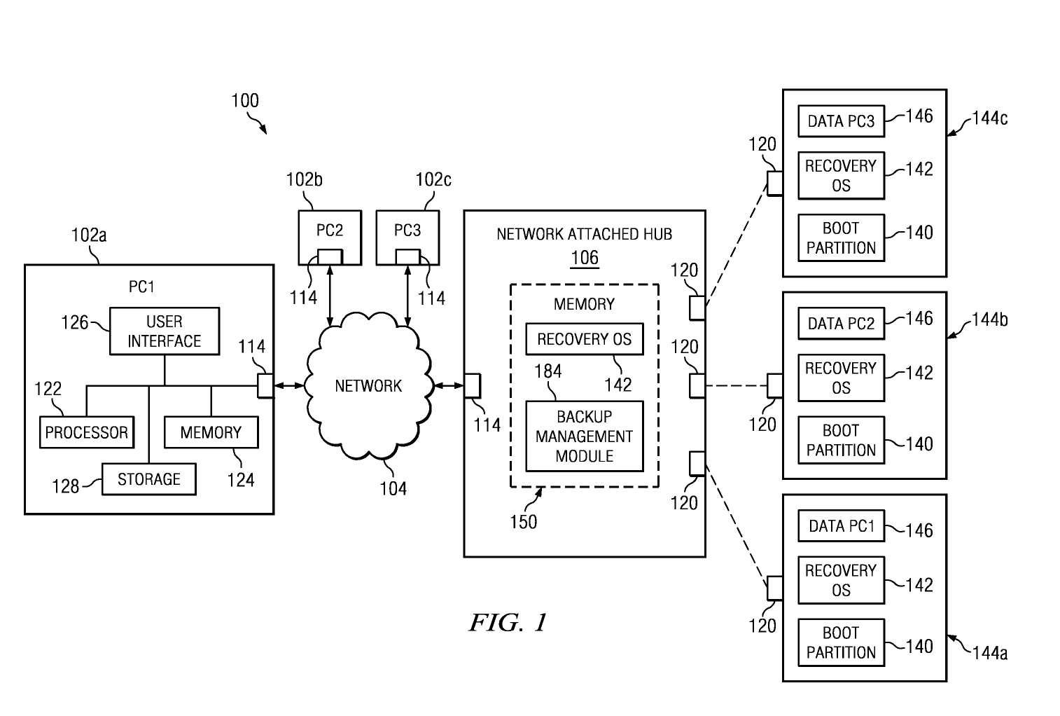

Preferred embodiments and their advantages are best understood by reference to FIGS. 1-3, wherein like numbers are used to indicate like and corresponding parts. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage resource, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, microwaves, radio waves, and other electromagnetic and/or optical carriers; and/or any combination of the foregoing.

For the purpose of this disclosure, “backup”, in general, may refer to making copies of data so that the additional copies may be used to restore an original set of data after a data loss event. For example, data backup may be useful to restore an information handling system to an operational state following a catastrophic loss of data (sometimes referred to as “disaster recovery”). In addition, data backup may be used to restore individual files after they have been corrupted or accidentally deleted.

FIG. 1 illustrates a block diagram of an example system 100 including a network attached hub 106 with one or more external storage resources 144, in accordance with certain embodiments of the present disclosure. As depicted, system 100 may include one or more information handling systems 102 (e.g., information handling systems 102a-c), a network attached hub 106, one or more external storage resources 144, and a network 104.

An information handling system 102 may generally be operable to receive data from, and/or transmit data to another device via network 104. In one embodiment, information handling system 102 may comprise a personal computer adapted for home use. In the same or alternative embodiments, information handling system 102 may comprise a personal computer adapted for business use. Also in FIG. 1, information handling system 102 may include a processor 122, a memory 124 communicatively coupled to the processor, a user interface 126 communicatively coupled to the processor 122, a local storage resource 128 communicatively coupled to processor 122, and a network interface 114 communicatively coupled to processor 122.

Processor 122 may comprise any system, device, or apparatus operable to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 122 may interpret and/or execute program instructions and/or process data stored in memory 124, storage resource 128, and/or another component of information handling system 102.

Memory 124 may be communicatively coupled to processor 122 and may comprise any system, device, or apparatus operable to retain program instructions or data for a period of time (e.g., computer-readable media). Memory 124 may comprise random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to information handling system 102 is turned off.

User interface 126 may be communicatively coupled to processor 122 and may include any instrumentality or aggregation of instrumentalities by which a user may interact with information handling system 102. For example, user interface 126 may permit a user to input data and/or instructions into information handling system 102 (e.g., via a keyboard, pointing device, and/or other suitable means), and/or otherwise manipulate information handling system 102 and its associated components. User interface 126 may also permit information handling system 102 to communicate data to a user, e.g., by means of a display device.

Local storage resource 128 may be communicatively coupled to processor 122 and/or memory 124 and may include any system, device, or apparatus operable to retain program instructions or data for a period of time (e.g., computer-readable media) and that retains data after power to information handling system 102 is turned off. Local storage resource 128 may include one or more hard disk drives, magnetic tape libraries, optical disk drives, magneto-optical disk drives, compact disk drives, compact disk arrays, disk array controllers, and/or any computer-readable medium operable to store data. Storage resource 128 may include an operating system (OS), data files, network configurations and application files.

Network interface 114 may include any suitable system, apparatus, or device operable to serve as an interface between information handling system 102 and network 104. Network interface 114 may enable information handling system 102 to communicate via network 104 using any suitable transmission protocol (e.g., TCP/IP) and/or standard (e.g., IEEE 802.11, Wi-Fi). In certain embodiments, network interface 114 may include a network interface card (NIC). In the same or alternative embodiments, network interface 114 may provide physical access to a networking medium and/or provide a low-level addressing system (e.g., through the use of Media Access Control addresses). In certain embodiments, network interface 114 may include a buffer for storing packets received from network 104 and/or a controller configured to process packets received from network 104.

Network 104 may be any suitable network and/or fabric for allowing network communications to/from system 100. Network 104 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). Network 104 may transmit data using any known storage and/or communication protocols. Network 104 and its various components may be implemented using hardware, software, or any combination thereof.

Network attached hub 106 may include any suitable system, apparatus, or device operable to store and manage large amounts of data for one or more information handling systems 102. Network attached hub 106 may also be operable to retain program instructions or large amounts data for a period of time (e.g., or a computer-readable medium integral to network attached hub 106) and that retains data after power to network attached hub 106 is turned off. Network attached hub 106 may include one or more hard disk drives, magnetic tape libraries, optical disk drives, magneto-optical disk drives, compact disk drives, compact disk arrays, disk array controllers, and/or any computer-readable medium operable to store data. Network attached hub 106 may also include, although not explicitly shown, a processor, a network controller, and/or expansion slots for more computer-readable media.

In addition, network attached hub 106 may also include a network interface 114 which may be similar to network interface 114 of information handling system 102 as described above. Network attached hub 106 may also include one or more standard interfaces 120 including, but not limited to, Universal Serial Bus (USB) interface, Serial Advance Technology Attachment (SATA) interface, Serial Attached SCSI (SAS) interface, or Fibre Channel interface operable to couple to an information handling system. These standard buses may be natively supported in Basic Input/Output Systems (BIOS) of information handling systems and, thus, may not require special provisions for network support or for writing to a boot drive for example. Network attached hub 106 may also include, although not explicitly shown, a processor operable to execute instructions for data backup and restoration (e.g., backup management module 184). Network attached hub 106 may also include one or more buses, such as SATA, SAS, USB, FireWire, or Fibre Channel, operable to transmit communications between the information system in the network.

In addition, network attached hub 106 may include memory 150 (e.g., a computer-readable medium) having stored thereon a boot partition 140 and recovery OS 142 for one or more information handling systems 102, and a backup management module 184 for executing backups or restorations of one or more information handling systems 102. Backup management module 184 may execute periodically, such as nightly for example, and/or may execute on demand. The backups may capture all of an information handling system 102's data or just recently updated data (e.g., a delta or change of data since the last backup) for storage on external storage resource 144 coupled to network attached hub 106. In addition, backup management module 184 may include resources configured to communicate details about the backup images to a display on network attached hub 106 and/or to a virtual console (e.g., web page).

An external storage resource 144 may include any suitable system, apparatus, or device operable to store and manage data and/or program instructions for one or more information handling systems 102. External storage resource 144 may also be configured to retain data and/or program instructions after power to external storage resource 144 is turned off. An external storage resource 144 may include one or more hard disk drives, magnetic tape libraries, optical disk drives, magneto-optical disk drives, compact disk drives, solid state disks (SSD), compact disk arrays, disk array controllers, flash memory and/or any computer-readable medium operable to store data. External storage resource 144 may include a recovery OS 142, a boot partition 140 which may be used to boot an information handling system 102 that may need data restoration from external storage resource 144 and/or data 146 for recovery of an information handling system 102. Data 146 that external storage resources 144 may store may include, for example, an operating system (OS), drivers, applications, files, user data, configurations, and/or other data suitable for execution and/or access by information handling system 102.

In addition, external storage resource 144 may also include one or more standard interfaces 120 including, but not limited to, Universal Serial Bus (USB) interface, Serial Advance Technology Attachment (SATA) interface, Serial Attached SCSI (SAS) interface, and/or Fibre Channel interface operable to couple to an information handling system 102. These standard buses may be natively supported in a Basic Input/Output System (BIOS) of an information handling system 102 and, thus, may not require special provisions for network support and/or for writing to a boot drive, for example.

In addition, each external storage resource 144a-c may be associated with a respective information handling system 102a-c by System Management Basic Input/Output System (SMBIOS) fields, Media Access Control (MAC) and/or other suitable data structure (not explicitly shown) present on the respective information handling system 102 resident in each information handling system 102. The SMBIOS standard describes access methods and data structures for uniquely identifying an information handling system 102. To be compliant with the SMBIOS standard, an information handling system may have a data structure that, at a minimum, stores information regarding the following: BIOS information, system information, system enclosure, processor, cache, system slots, physical memory array, memory device, memory array mapped addresses, memory device mapped addresses and system boot information. Additional information about system configuration, jumper settings, memory controllers and modules, devices, ports and connectors and power may be stored also, but it is not required to be compliant with the SMBIOS specification. The SMBIOS structures are usually populated at system boot time so any information stored in the SMBIOS data structure that dynamically changes after system boot may not be updated. For example, if a device is hot-plugged, added or removed, the SMBIOS may not reflect this. Therefore, the SMBIOS information used to match a backup image to an individual information handling system 102 should be one that does not dynamically change after system boot. The Media Access Control (MAC) address is a unique identifier assigned to an information handling system. The MAC address may be stored in Read Only Memory (ROM) on a Network Interface Card (NIC) in the information handling system. The MAC address may be used to communicate between information handling systems on a network.

Although FIG. 1 depicts information handling system 102, including processor 122, memory 124, user interface 126, and storage 128, any suitable number and/or type of devices may be included in information handling system 102. In addition, although FIG. 1 depicts information handling system 102 communicatively coupled via network 104 to network attached hub 106, any suitable number and/or types of devices, some of which may be in a separate location, may be communicatively coupled to network 104. In addition, the devices in FIG. 1 maybe coupled in a wire-less or wire-line configuration. The devices may be configured in a WAN, LAN or other suitable network configuration. The devices in the network may communicate via any protocol suitable for communication with information handling system via wireless or wire-line networks. In addition, although FIG. 1 depicts network attached hub 106 and external storage resource 144 including memory, network interfaces, buses, ports and programs, any suitable configuration of memory, programs and interfaces, ports or buses may be included.

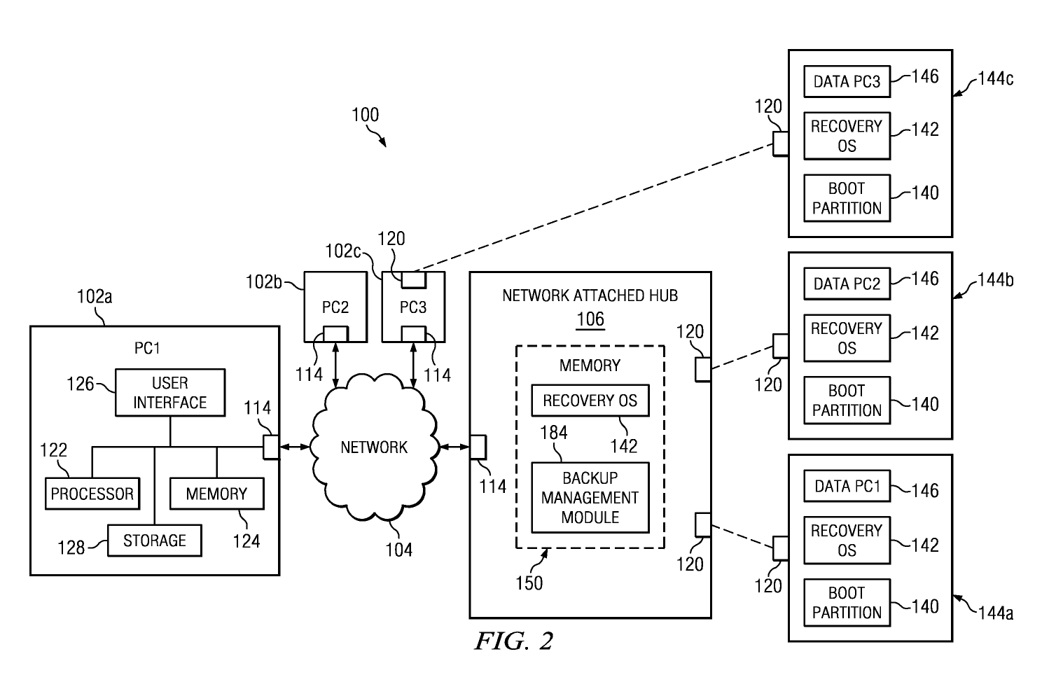

FIG. 2 illustrates a block diagram of an example configuration of system 100 in which recovery of an information handling system 102 is performed from a backup, in accordance with certain embodiments of the present disclosure. Typically, in an information handling system, the OS is stored in the hard drive and the BIOS is stored in a Flash EEPROM (Electrically Erasable Programmable Read Only Memory) or Read Only Memory (ROM). At power up, the BIOS may search for a bootable device, such as a hard drive, within the system. Once the bootable device is located, the bootable device may boot and load the OS into Random Access Memory (RAM) for execution. However, when a hard drive fails, the process just described may not occur. As discussed above, a user typically has to have knowledge of network addresses or must locate a boot CD in order to boot the information handling system and execute programs to restore the information handling system to an operational state.

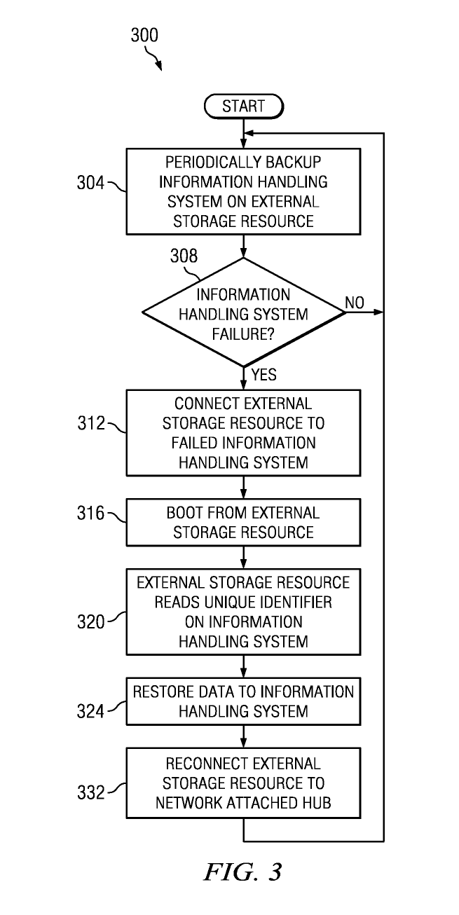

However, in embodiments of the present disclosure, external storage resource 144 may include a boot partition 140 and recovery OS 142. For example, to initiate recovery of information handling system 102c, a person may couple external storage resource 144c to the failed information handling system 102c via bus interface 120 and boot information handling system 102c. The BIOS on information handling system 102c may search for a boot partition, may locate boot partition 140 on external storage resource 144c and boot from external storage resource 144c. The BIOS may also be configured to select external storage resource 144c first if a local boot partition is not available. In addition, a user may utilize mechanisms within the BIOS to initiate booting from external storage resource 144. Recovery OS 142 may then initiate a restore of the data on the hard drive of information handling system 102c using data 146 previously backed up to external storage resource 144c during backup operations. Once the data has been restored, information handling system 102c may be rebooted and normal execution of the information handling system 102c may resume. In addition, backups may continue as normal for information handling systems 102a-b on external storage resources 144a-b while the data restoration takes place on information handling system 102c. Further details of this process are described in FIG. 3.

FIG. 3 illustrates a flow chart of a method 300 for recovery from a backup, in accordance with certain embodiments of the present disclosure. According to one embodiment, method 300 may begin at step 304. As noted above, teachings of the present disclosure may be implemented in a variety of configurations of system 100. As such, the preferred initialization point for method 300 and the order of the steps 304-332 comprising method 300 may depend on the implementation chosen.

At step 304, the information handling systems in a system may be in normal operation, and periodic backups of each information handling system may be executed. The backups of each information handling system may be stored on an external storage resource coupled to network attached hub coupled to each information handling system via a network.

In step 308, the working status for each information handling system may be monitored. The information handling systems may be polled to determine if a failure has occurred. For example, failure of a backup to complete or another event may indicate that a failure has occurred. In addition, a user may determine that there is a hardware failure within the information handling system. If all systems are executing in normal operation without failure, method 300 may return to step 304. Otherwise, if an information handling system failure is detected, method 300 may proceed to step 312.

At step 312, an external storage resource storing backups may be removed from the network and locally coupled to the failed information handling system. The information handling system and the external storage resource may be locally coupled via a USB bus or other suitable bus.

At step 316, the failed information handling system may be rebooted and the BIOS on the information handling system may search for a bootable device. Once it has located the boot partition on the external storage resource, the BIOS may turn over control to the external storage resource. In alternate embodiments, a user may use mechanisms within the BIOS to direct the information handling system to boot from the external storage resource. Because the boot partition is located on the external storage resource (now locally attached), there is not a need for a network driver or booting over a network. This reduces complexity and restore time since the restore is completed locally. In step 320 the external storage resource, which is now locally attached may read the unique identifier on the information handling system. The unique identifier may include SMBIOS data structures, a Media Access Control (MAC) address, and/or other suitable unique identifier, for example, located on the information handling system to confirm the identity of the information handling system and/or which components or devices are present in the information handling system. Such information may allow the external storage resource to determine if it is attached to the appropriate information handling system and/or which image on the external storage resource to restore to the information handling system. In step 324, the external storage resource may execute one or more programs of instructions (e.g., a backup management module) to restore data to the information handling system.

At step 332, once the restore is complete, the external storage resource may be decoupled from the information handling system and returned to its normal position on the network attached hub. After completion of step 332, method 300 may return to step 304.

Although FIG. 3 discloses a particular number of steps to be taken with respect to method 300, it is understood that method 300 may be executed with greater or lesser steps than those depicted in FIG. 3. In addition, although FIG. 3 discloses a certain order of steps to be taken with respect to method 300, the steps comprising method 300 may be completed in any suitable order. Method 300 in FIG. 3 may be implemented using system 100 shown in FIGS. 1 and 2 or any other system operable to implement method 300. In certain embodiments, method 300 may be implemented partially or fully in software embodied in tangible computer-readable media.

Although the present disclosure has been described in detail, it should be understood that various changes, substitutions, and alterations can be made hereto without departing from the spirit and the scope of the invention as defined by the appended claims.

What is claimed is:

1. A system comprising:
a processor;
a network interface coupled to the processor and configured to interface to a network;
a backup management module configured to, when executed by the processor, backup data associated with one or more information handling systems communicatively coupled to the network interface; and
a memory communicatively coupled to the processor and having stored in a boot partition of the memory a program of instructions configured to, when executed by a second processor of an information handling system to which the memory is locally coupled:
boot the information handling system to which the memory is locally attached; and
restore data associated with the information handling system to which the memory is locally attached.

2. A system according to claim 1, the program of instructions configured to boot and restore the data to the information handling system to which the memory is locally coupled when the information handling system is communicatively coupled to the memory via one of a Universal Serial Bus (USB), Serial Attached SCSI (SAS) bus, Serial Attached Technology Advancement (SATA) bus and Fibre Channel bus.

3. A system according to claim 1, the program of instructions further configured to, when executed by the second processor:
determine an identity of the information handling system to which the memory is locally attached; and
restore data to the information handling system to which the memory is locally coupled based on the identity.

4. A system according to claim 3, wherein determining the identity comprises reading at least one of a SMBIOS data structure or a Media Access Control (MAC) Address of the information handling system to which the memory is locally coupled.

5. A system according to claim 1, the system further comprises a networked attached hub, where the memory and the processor are internal to the network attached hub.

6. A system according to claim 5, the backup management module further configured to backup data associated with a particular information handling system to a single external storage resource.

7. A method for backing up and restoration of data of an information handling system, comprising:
copying data from an information handling system to a memory communicatively coupled to the information handling system via a network;
locally communicatively coupling the memory to the information handling system after a failure of the information handling system;
booting the information handling system from the locally attached memory; and
restoring copied data to the information handling system from the locally attached memory.

8. A method according to claim 7, further comprising:
determining an identity of the information handling system to which the memory is locally attached; and
restoring copied data to the information handling system based on the identity.

9. A method according to claim 8, wherein identifying the information handling system comprises reading at least one of a System Management BIOS (SMBIOS) data structures or Media Access Control (MAC) Address on the information handling system.

10. A method according to claim 7, wherein locally communicatively coupling the memory to the information handling system comprises coupling the memory and the information handling system via one or more of a Universal Serial Bus (USB), a Serial Attached SCSI (SAS) bus, a Serial Attached Technology Advancement (SATA) bus, and a Fibre Channel bus.

11. A method according to claim 7, wherein booting the information handling system from the memory comprises the Basic Input/Output System (BIOS) of the information handling system locating the memory as the boot device.

12. A method according to claim 7, wherein copying data to the memory comprises copying data to a single external storage resource.

13. An article of manufacture, comprising:
a computer-readable medium;
computer-executable instructions carried on the computer-readable medium, the instructions readable by an information handling system, the instructions, when executed, for causing a processor to:
copy data from an information handling system communicatively coupled to a memory via a network;
determine an identity of the information handling system that the memory is locally attached to;
boot the information handling system from the memory; and
restore copied data to the information handling system.

14. An article of manufacture according to claim 13, the processor further caused to determine the identity of the information handling system by reading at least one of the System Management BIOS (SMBIOS) data structures or the Media Access Control (MAC) address on the information handling system.

15. An article of manufacture according to claim 13, the processor further caused to copy data to a single external storage resource attached hereto.
